(19) United States
(12) Patent Application Publication
(10) Pub. No.: US 2009/0168156 A1
(43) Pub. Date: Jul. 2, 2009

(54) MICROSCOPE SYSTEM, MICROSCOPE SYSTEM CONTROL PROGRAM AND MICROSCOPE SYSTEM CONTROL METHOD

(75) Inventor: Naohiro Ariga, Tokyo (JP)

Correspondence Address: FRISHAUF, HOLTZ, GOODMAN & CHICK, P.C., 220 Fifth Avenue - 16th Floor, New York, NY, 10017-2023, US

(73) Assignee: Olympus Corporation, Tokyo (JP)

(21) Appl. No.: 12/396,727

(22) Filed: Mar. 3, 2009

(30) Foreign Application Priority Data
Sep. 4, 2007 (JP) 2007-229507

(51) Int. Cl. G02B 21/00

(52) U.S. Cl. 359/381

(57) ABSTRACT

A microscope system comprising a microscope; an objective lens switching unit switching objective lenses placed in an observation light path; an imaging unit; a storage unit storing optical characteristic information of each of the objective lenses; a light amount difference calculation unit obtaining optical characteristic information of a first of the objective lenses before switching performed by the objective lens switching unit and optical characteristic information of a second of the objective lenses after the switching, and calculating a difference in amounts of light passing through the two objective lenses; and an exposure calculation unit calculating an exposure time for a case of performing image capturing through the second objective lens, on the basis of a first observed image captured through the first objective lens, an exposure time for the first observed image, and the calculated difference in the amounts of light.

### CROSS REFERENCE TO RELATED APPLICATIONS

This application is based upon the prior Japanese Patent Application No. 2007-229507, filed Sep. 4, 2007, the entire contents of which are incorporated herein by reference.

### BACKGROUND OF THE INVENTION

1. Field of the Invention

The present invention relates to a microscope system in which a sample can be observed with a microscope and the observed image of the sample can be recorded.

2. Description of the Related Art

In the conventional microscopic observation, switch from rough observation of the entirety of a sample with a wide field of view to finer observation is realized by partly switching objective lenses. However, when objective lenses are switched, the brightness of the observed image changes, because each objective lens transmits a different amount of light, depending on its aperture angle, transmittance, focal length and so on.

For this reason, when switching objective lenses in such a situation, automatic exposure (AE) control is performed so that appropriate exposure can be obtained some time after objective lenses are switched in fluorescent observation and the like.

### SUMMARY OF THE INVENTION

A microscope system according to an embodiment of the present invention comprises a microscope with which a sample mounted on a stage is observed; an objective lens switching unit switching objective lenses placed in an observation light path; an imaging unit obtaining an observed image from the microscope; a storage unit storing optical characteristic information of each of the objective lenses; a light amount difference calculation unit obtaining optical characteristic information of a first of the objective lenses before switching performed by the objective lens switching unit and optical characteristic information of a second of the objective lenses after the switching from the storage unit, and calculating a difference in amounts of light passing through the two objective lenses; and an exposure calculation unit calculating an exposure time for a case of performing image capturing through the second objective lens, on the basis of a first observed image captured through the first objective lens, an exposure time for the first observed image, and the calculated difference in the amounts of light.

A storage medium storing a microscope system control program according to an embodiment of the present invention causes a computer to perform processes to control a microscope system comprising a microscope with which a stage mounted on a stage is observed, an objective lens switching mechanism switching objective lenses placed in an observation light path and an image capturing apparatus obtaining an observed image from the microscope, the processes comprising a light amount difference calculation process for obtaining optical characteristic information of a first of the objective lenses before switching performed by the objective lens switching mechanism and optical characteristic information of a second of the objective lenses after the switching from a storage apparatus storing optical characteristic information of each of the objective lens, and calculating a difference in amounts of light that passes through the two objective lenses; and an exposure time calculation process calculating an exposure time for a case of performing image capturing through the second objective lens, on the basis of a first observed image captured through the first objective lens, an exposure time for the first observed image, and the calculated difference in the amounts of light.

A microscope system control method according to an embodiment of the present invention is for a microscope system comprising a microscope with which a stage mounted on a stage is observed, an objective lens switching mechanism switching objective lenses placed in an observation light path and an image capturing apparatus capturing an observed image from the microscope, and comprises obtaining optical characteristic information of a first of the objective lenses before switching performed by the objective lens switching mechanism and optical characteristic information of a second of the objective lenses after the switching from a storage apparatus storing optical characteristic information of each of the objective lens, and calculating a difference in amounts of light passing through the two objective lenses; and calculating an exposure time for a case of performing image capturing through the second objective lens, on the basis of a first observed image captured through the first objective lens, an exposure time for the first observed image, and the calculated difference in the amounts of light.

### BRIEF DESCRIPTION OF THE DRAWINGS

FIG. 1 illustrates the configuration overview of a microscope system according to the first embodiment (example 1).

FIG. 2 illustrates the operation flow of microscope system in the first embodiment (example 1).

FIG. 3 illustrates the configuration overview of a microscope system according to the first embodiment (example 2).

FIG. 4 illustrates the operation flow of the microscope system in the first embodiment (example 2).

FIG. 5 illustrates the configuration overview of a microscope system according to the second embodiment.

FIG. 6 illustrates the configuration overview of a microscope according to the second embodiment.

### DESCRIPTION OF THE EMBODIMENTS

In a microscope system according to the embodiment of the present invention, an appropriate exposure time after the switching of objective lenses is calculated in advance using optical characteristic information of the objective lenses and other optical characteristic information. This makes it possible to shorten the time in which the exposure time after the actual switching reaches the original optimal exposure time.

A microscope system according to the embodiment of the present invention has a microscope, an objective lens switching unit, an imaging unit, a storage unit, a light amount difference calculation unit, and an exposure calculation unit.

The microscope is used to observe a sample mounted on a stage.

The objective lens switching unit switches the objective lenses placed in the observation light path. The objective lens switching unit corresponds to, in the embodiment of the present invention for example, a revolver 11, 11a, 213.

The image capturing unit obtains an observed image from the microscope. The image capturing unit corresponds to, in the embodiment of the present invention for example, an image sensor 5.

The storage unit stores the optical characteristic information of each objective lens. The optical characteristic information storage unit corresponds to, in the embodiment of the present invention for example, an optical characteristic information storage unit 3.

The light amount difference calculation unit obtains, from the storage unit, the optical characteristic information of the first objective lens before the switching performed by the objective lens switching unit, and the optical characteristic information of the second objective lens after the switching; and calculates the difference in the amounts of light passing through the two lenses. The light amount difference calculation unit corresponds to, in the embodiment of the present invention for example, a light amount difference comparison unit 4.

The exposure calculation unit calculates the exposure time in the case of performing image capturing through the second objective lens, on the basis of the first observed image captured through the first objective lens, its exposure time, and the calculated difference in the amounts of light. The exposure calculation unit corresponds to, in the embodiment of the present invention for example, an exposure calculation unit 9.

The configuration described above makes it possible to save the time and labor to obtain information in advance for each field of view under the same condition. A reasonable exposure time after the switching of objective lenses is calculated in advance using optical characteristic information of the objective lenses and other optical characteristic information. This makes it possible to shorten the time required to attain the original optimal exposure time after the actual switching.

The microscope system further has an objective lens type detection unit. The objective lens type detection unit is capable of detecting the type of the objective lens placed in the observation light path. The objective lens type detection unit corresponds to, in the embodiment of the present invention for example, an objective lens type detection unit 2. This configuration makes it possible to detect the type of the objective lens being switched.

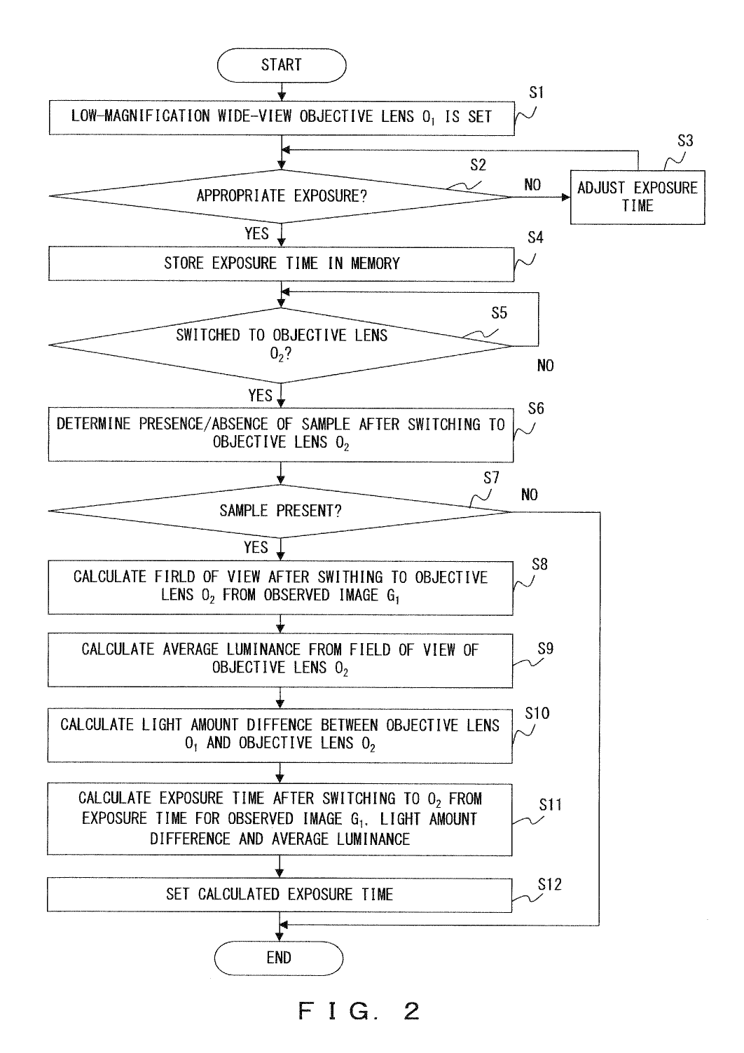

The microscope system further has a sample presence determination unit. The sample presence determination unit calculates the luminance information of the pixel area corresponding to the second observed image captured through the second objective lens, from the first observed image. Then the sample presence determination unit determines a presence/absence of the sample in the second observed image on the basis of a result of the calculation. When the sample presence determination unit determines that the sample is present in the second observed image, the exposure calculation unit can calculate the exposure time. The sample presence determination unit corresponds to, in the embodiment of the present invention for example, the processes of S6 and S7 in FIG. 2.

The microscope system further has a position selection unit and a stage moving unit.

The position selection unit makes it possible to select, within the first observed image, the position of the observed image captured through the second objective lens. The position selection unit is, in the embodiment of the present invention for example, a predetermined frame 103 provided in an observed image or input unit 13 for setting the frame 103. When the observed image obtained by using a low-magnification objective lens is displayed on a monitor 102, the predetermined frame 103 is drawn by a mouse drag operation, to enclose the area to be the object of a detail observation within the observed image.

The stage moving unit moves the stage such that the position selected by the position selection unit comes to the center of the field of view area in the observation using the second objective lens. The stage moving unit is, in the embodiment of the present invention for example, a motorized stage 101a.

With the configuration described above, the zoom magnification changes in accordance with the size of the area enclosed with the frame 103; the motorized stage 101a moves to the center of the area enclosed with the frame 103; and then the lens is switched to a high-magnification one, making it possible to display a detail image of the area enclosed with the frame 103.

The storage unit further stores the optical characteristic information of optical elements other than the objective lens placed in the observation light path. In this case, the light amount difference calculation unit can calculate the difference in the amounts of light passing through the first and second objective lenses, from the optical characteristic information of the optical elements including the objective lens.

This configuration makes it possible to calculate an appropriate exposure time, in consideration of the optical elements other than the objective lens.

Hereinafter, embodiments of the present invention are described in detail.

### First Embodiment

Using the automatic exposure (AE), there is a problem that if no sample is present when objective lenses are switched in a fluorescent observation and the like, the exposure time becomes too long. There is also a disadvantage that the time required to attain an appropriate exposure time is originally long, causing the sample to be subjected to the damage from the light for a longer period of time.

In recent years, there has been a microscope system in which the image of the whole sample is obtained in advance with a wide-view objective lens; a position is specified in the whole-sample image; and high-definition observed image of the position is displayed. However, conventionally, in order to display the high-definition observed image with appropriate brightness, it requires some waiting time until an appropriate exposure time is attained.

Meanwhile, according to Japanese Patent Application Publication 2006-317406, the exposure condition for each field of view is recorded in advance, and when displaying an observed image, the optimal exposure time is set again, on the basis of the recorded exposure condition. However, according to Japanese Patent Application Publication 2006-317406, extra labor is required to record the exposure condition for each field of view in advance.

In view of the above, the present invention provides a microscope system in which the time required to attain the original exposure state after the switching of objective lenses is shortened.

### Example 1

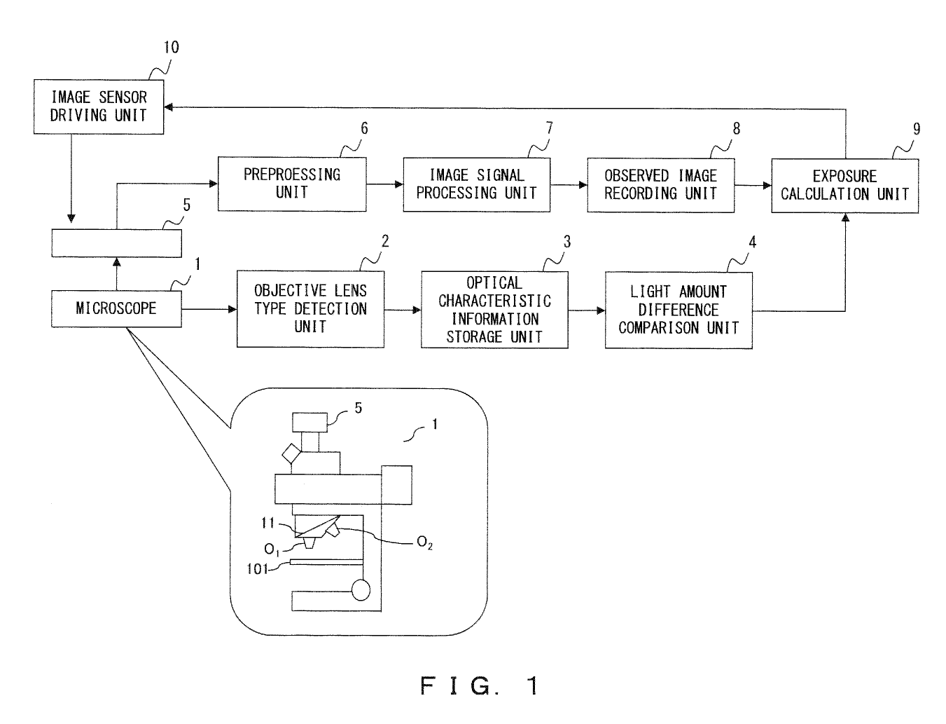

FIG. 1 illustrates the configuration overview of a microscope system according to the first embodiment (example 1). The microscope system is composed of a microscope 1, an objective lens type detection unit 2, an optical characteristic information storage unit 3, a light amount difference comparison unit 4, an image sensor 5, a preprocessing unit 6, an image signal processing unit 7, an observed image recording unit 8, an exposure calculation unit 9, and an image sensor driving unit 10.

The microscope 1 is a microscope with which a sample mounted on the stage 101 can be observed using various microscopic methods such as transparent bright-view observation or fluorescent observation. The microscope 1 is equipped with a revolver 11 that holds a plurality of objective lenses. The objective lenses provided on the revolver 11 respectively has a different magnification. The sample can be observed with a desired magnification by selecting the objective lens to be used for the observation.

The objective lens type detection unit 2 is a unit that detects the type of the objective lens set in the light path or the type of the objective lens after the switching. In this regard, the objective lens type detection unit 2 may determine the type of the objective lens on the basis of the position information of the revolver 11. In addition, the objective lens type detection unit 2 may be composed of a unit that can issue an instruction in advance to specify the objective lenses to be switched, and a motorized revolver that performs the switching in accordance with the instruction. The objective lens type detection unit 2 transmits, to the optical characteristic information storage unit 3, the information about the type of the lens before and after switching.

The optical characteristic information storage unit 3 transmits, to the light amount difference comparison unit 4, the optical characteristic information about the objective lens before the switching and the optical characteristic information about the objective lens after the switching. The light amount difference comparison unit 4 calculates the difference in the amounts of light passing through the objective lenses before and after the switching on the basis of the optical characteristic information obtained from the optical characteristic information storage unit 3, and transmits the difference in the amounts of light to the exposure calculation unit 9.

The exposure calculation unit 9 calculates the exposure time after the switching of the objective lenses, on the basis of the observed image obtained from the observed image recording unit 8, the difference in the amounts of light obtained by the light amount difference comparison unit 4, the magnification information of the objective lens, and the exposure time before the switching of the objective lenses. The exposure calculation unit 9 transmits the calculated exposure time to the image sensor driving unit 10 as an initial value.

The image sensor 5 is, for example, a CCD (Charge Coupled Devices) image sensor or a CMOS (Complementary Metal-Oxide Semiconductor) image sensor. The preprocessing unit 6 is connected to the image sensor 5.

The preprocessing unit 6 converts an output signal from the image sense 5 into a picture signal and outputs the picture signal. The image signal processing unit 7 applies signal processing such as white balance adjustment and gray level correction to the picture signal converted by the preprocessing unit 6, which is then input to and stored in the observed image recording unit 8.

FIG. 2 illustrates the operation flow of the microscope system in the first embodiment (example 1). In the descriptions below, the elements related to the use of a low-magnification wide-view lens are illustrated with a subscript “1”. The elements related to the use of a high-magnification narrow-view lens are illustrated with a subscript “2”.

A low-magnification wide-view objective lens O₁ is in a condition in which it is set in the light path of the microscope 1. At this time, the observed image of a sample set on the stage 101 is captured by the image sensor 5 through the objective lens O₁, and is subjected to photoelectric conversion. An electric signal output from the image sensor 5 is converted into a picture signal by the preprocessing unit 6. The picture signal converted by the preprocessing unit 6 is subjected to the gray scale correction and white balance adjustment by the image signal processing unit 7, and recorded in the observed image recording unit 8 as an observed image (Step 1. Hereinafter, Step is indicated as “S”.).

The exposure calculation unit 9 determines, about the observed image stored in the observed image recording unit 8, whether or not the exposure condition is appropriate (S2). When the average luminance of the observed image recorded in the observed image recording unit 8 is not positioned around the middle of the expressible gray-scale range, the exposure calculation unit 9 determines that the exposure time is not appropriate (the process proceeds to “NO” in S2), and the exposure time is adjusted (S3).

An observed image is recorded again in accordance with the adjusted exposure time, and the exposure calculation unit 9 repeats the adjustment process until the average luminance is positioned around the middle of the gray scale range (S2, S3).

When the exposure calculation unit 9 determines that the appropriate exposure time has been obtained on the basis of the average luminance (the process proceeds to “YES” in S2), the exposure calculation unit 9 records the exposure time E₁ at that time in a memory (S4).

The objective lens type detection unit 2 stands by (the process proceeds to “NO” in S5) until the objective lenses are switched. When the objective lens type detection unit 2 determines that the objective lenses have been switched (the process proceeds to “YES” in S5), the objective lens type detection unit 2 identifies the type of the objective lens that is currently inserted into the light path, on the basis of the position information of the revolver 11 after the switching.

The exposure calculation unit 9 specifies, in an observed image G₁ recorded through the objective lens O₁ before switching, the area corresponding to the field of view area of an objective lens O₂ after the switching, on the basis of the ratio between the magnifications of the objective lenses before and after the switching. It is assumed here that the objective lens O₂ after the switching has a higher magnification and narrower field of view than those of the objective lens O₁ before the switching.

The exposure calculation unit 9 determines, on the observed image G₁, whether or not a sample is present in the specified field of view of the objective lens O₂ (S6). A method of determining the presence/absence of the sample is to clip out the field of view area of the objective lens O₂ on the observed image. When the luminance histogram of the partial image from which noises are removed is unequally distributed towards a certain luminance value, and the edge detection amount is equal to or smaller than a predetermined value, the exposure calculation unit 9 determines that no sample is present. In a luminance histogram of an image with only the background captured using the bright-view observation, the luminance data exist in the bright area only. In a luminance histogram of a background-only image captured with fluorescent observation, the luminance data exist in the dark area only.

The exposure calculation unit 9 has specified the area on the observed image G₁ corresponding to the field of view area of the objective lens O₂. At this time, when the exposure calculation unit 9 determines that no sample is present in the field of view area of the objective lens O₂ and that it is an observed image G₂ with the background only (the process proceeds to “NO” in S7), the exposure calculation unit 9 fixes the exposure time at a preset value, and does not calculate the initial value of the exposure time after that.

When the exposure calculation unit 9 determines that a sample is present in the field of view area of the objective lens O₂ on the observed image (the process proceeds to “YES” in S7), the exposure calculation unit 9 calculates the pixel area corresponding to the field of view area of the objective lens O₂ from the observed image G₁ (S8).

The exposure calculation unit 9 then calculates and stores, in the memory, an average luminance P₁ₚ of the pixel area corresponding to the field of view area of the objective lens O₂ obtained in S8 (S9).

The light amount difference comparison unit 4 calculates an initial value of the exposure time. For that purpose, the light amount difference comparison unit 4 calculates the difference in the amounts of light passing through the two types of objective lenses, on the basis of the optical characteristic information (the objective lens's transmittance T, focal length f, aperture angle θ, brightness I, and soon) of the objective lens O₁ and the objective lens O₂ (S10).

As an example of the method of calculating the difference in the light amount, the difference a in the amounts of light can be obtained from the following equation (1), assuming the transmittance of the objective lenses O₁ and O₂ as T₁ and T₂, their focal length as f₁ and f₂, their aperture angle as θ₁ and θ₂, their brightness as I₁ and I₂, respectively.

α=I₂/I₁=T₂(f₂ tan θ₂)²/T₁(f₁ tan θ₁)² (1)

The brightness of the objective lens is calculated from the transmittance, focal length and aperture angle. However, the average luminance obtained when a background image without a sample is captured under the same exposure condition may simply be used as the brightness information of each objective lens.

Next, the exposure calculation unit 9 calculates the exposure time after the switching to the objective lens O₂, on the basis of an exposure time E₁ of the observed image G₁, difference in the amounts of light and average luminance (S11). A rough estimate value can be given for the average luminance P₂ after the switching from the objective lens O₁ to the objective lens O₂ with the following equation (2).

P₂=αP₁ₚ (2)

Here, α represents the difference in the amounts of light, and P₁ₚ represents the average luminance (the average luminance calculated in S9) of the pixel area corresponding to the observed image G₂ in the observed image G₁.

The exposure time can be adjusted such that the average luminance P₂ is positioned in the middle of the expressible luminance gray scale range. For example, an exposure time initial value E₂ can be given using the following equation (3), assuming the optimal exposure time with the objective lens O₁ as E₁ and an average luminance of the observed image G₁ with the objective lens O₁ as P₁.

E₂=(P₂/P₁)E₁ (3)

The exposure calculation unit 9 sets the calculated exposure time initial value E₂ in the image sensor driving unit 10 (S12). The image sensor driving unit 10 is capable of driving the image sensor 5 in accordance with the set exposure time initial value E₂ to perform image capturing.

Thus, an appropriate initial value of the exposure time can be given when the objective lenses are switched, shortening the time required to attain the optimal exposure time.

### Example 2

In Example 1, the type of the objective lens is determined by the objective lens type detection unit 2 on the basis of the position information of the objective lens after the switching. By contrast, in this example, the type of the objective lens is determined, after a switching instruction is issued, immediately before the switching of the objective lenses using the motorized revolver 11a that is driven by a motor,

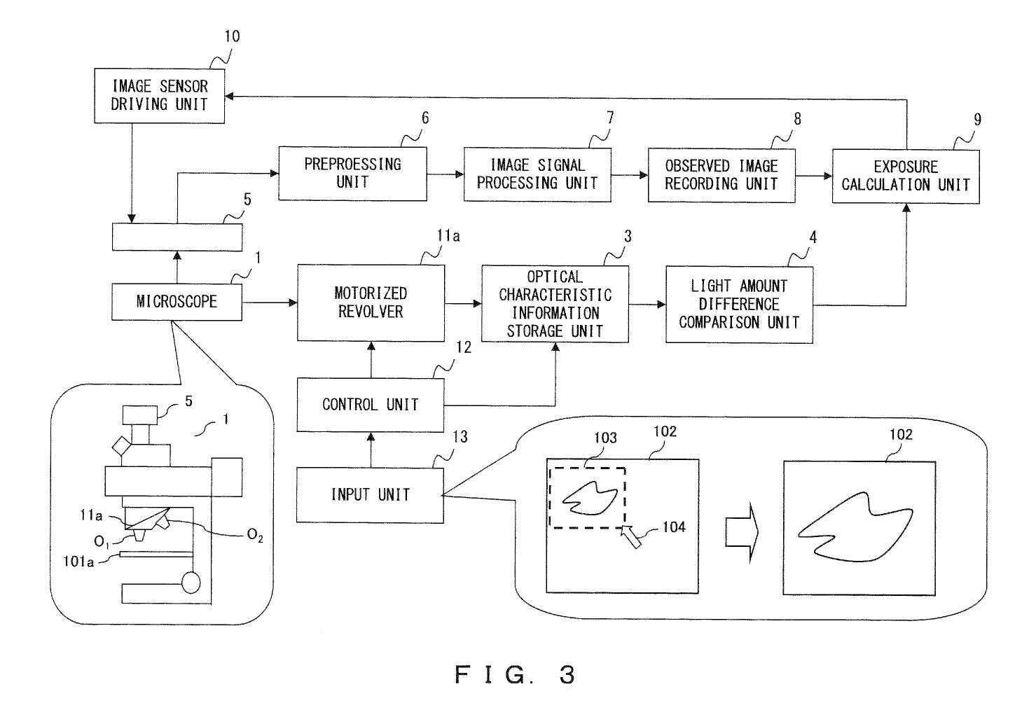

FIG. 3 illustrates the configuration overview of a microscope system according to the first embodiment (example 2). Compared to FIG. 1, the microscope system in FIG. 3 does not have the objective lens type detection unit 2 but additionally has a motorized revolver 11a, a control unit 12 and an input unit 13.

The stage 101a used in this example is a motorized stage. In the motorized stage 101a, the stage part on which a sample is mounted moves in X, Y and Z directions.

The input unit 13 is an apparatus to which operation instructions from an operator performing the observation are input. The control unit 12 controls each motorized unit that constitutes the microscope . The control unit 12 may be a control apparatus built within the microscope, or may be a personal computer, control box and the like.

The motorized revolver 11a is controlled by the control unit 12 that has received the operation instructions input to the input unit 13, and is capable of rotating the revolver in accordance with the input instructions to perform switching to a desired objective lens.

The control unit 12 may be, for example, a personal computer (PC) having a monitor 102. The input unit 13 may be an input device such as a keyboard, mouse and the like. In this case, the operation can be performed as follows. First, an observed image obtained through observation using a low-magnification objective lens is displayed on the monitor 102. An area for which detail observation is to be performed within the observed image is enclosed with a predetermined frame 103 using mouse pointer 104 by a mouse drag operation. Then, the zoom magnification changes in accordance with the size of the area enclosed with the frame 103. Further, the motorized stage 101a moves to the center position of the area enclosed with the frame 103. After that, switching to a high-magnification objective lens is performed, and a detail image of the area enclosed with the frame 103 is displayed.

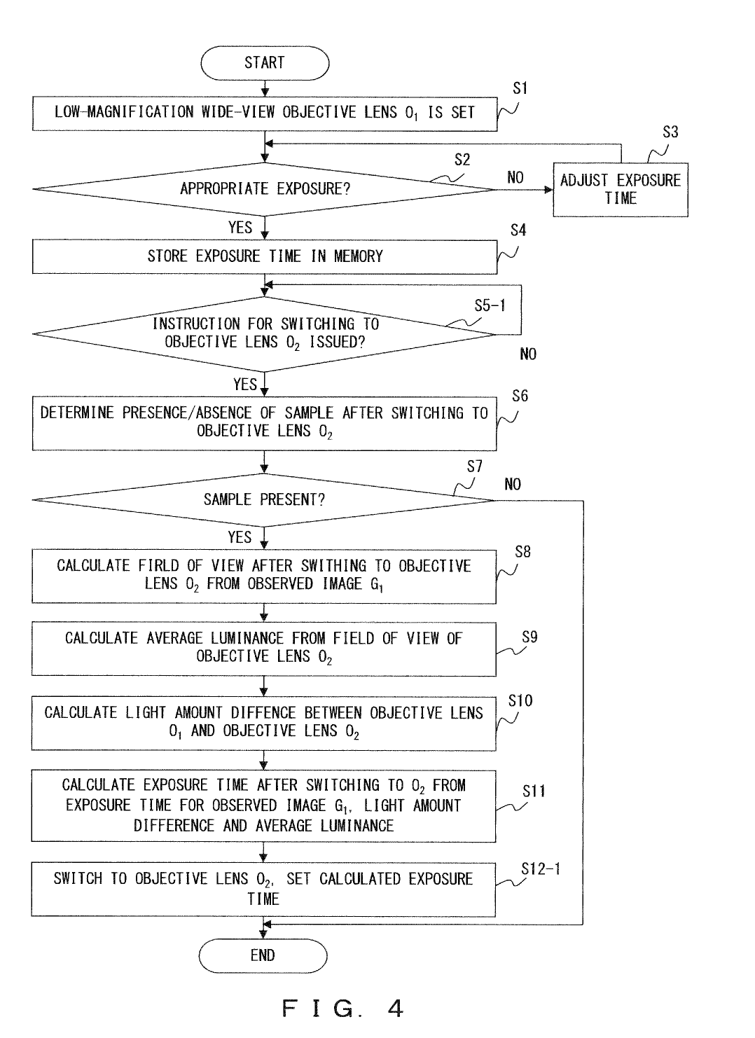

FIG. 4 illustrates the operation flow of the microscope system in the first embodiment (example 2). In FIG. 4, when the control unit 12 receives an instruction for switching objective lenses from the input unit 13 in S5-1, the process proceeds to S6. Then, in S12-1, the control unit 12 drives the motorized revolver 11a to perform the switching to the objective lens in accordance with the switching instruction, and sets the exposure time initial value E₂ calculated by the exposure calculation unit 9 in the image sensor drive unit 10. The processes except for S5-1 and S12-1 are the same as in FIG. 2, and explanation for the same processes is omitted here.

Thus, the exposure time initial value after the switching of the objective lenses can be calculated immediately after the input of an instruction for the switching of the objective lenses using the input unit 13. Therefore, the calculation of the exposure time initial value can be performed in parallel with the switching operation of the objective lenses, saving time to calculate the exposure time initial value separately.

As descried above, while the exposure time initial value is calculated after the switching of the objective lenses in Example 1, the calculation of the exposure time initial value can be started before the switching of the objective lenses, and the calculated exposure time can be set at the same time with the completion of the switching in Example 2. Therefore, the time required for the exposure time for the observed image through the high-magnification narrow-view objective lens after the switching to settle into the optimal exposure time can be shortened.

### Second Embodiment

In the first embodiment, the exposure time is calculated with in consideration of the objective lenses only. By contrast, in this embodiment, the exposure time is calculated with additional consideration of optical elements other than the objective lenses. An example of the embodiment described below corresponds to the case where various settings for the microscope are changed with the switching from a wide-view observed image to a narrow-view observed image.

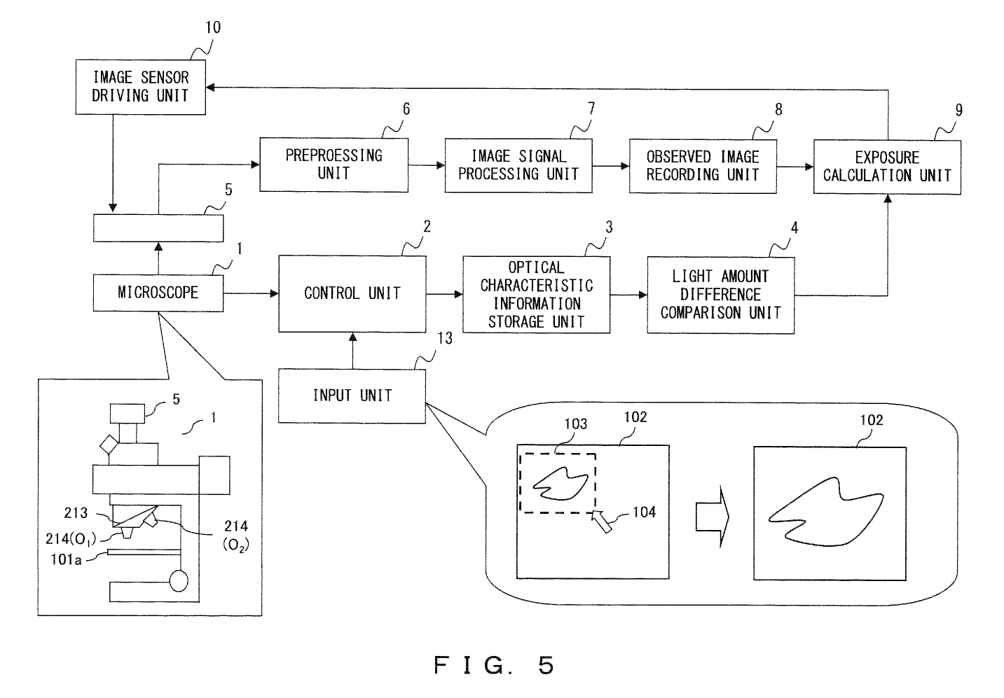

FIG. 5 illustrates the configuration overview of a microscope system according to the second embodiment. Compared to FIG. 1, the microscope system in FIG. 5 does not have the objective lens type detection unit 2, but additionally has the control unit 12 and the input unit 13. Meanwhile, the stage used in this embodiment is a motorized stage 101a in which a stage part on which a sample is mounted can move in X, Y and Z directions.

The control unit 12 may be, for example, a personal computer (PC) having a monitor 102. The input unit 13 may be an input device such as a keyboard, mouse and the like. In this case, the operation can be performed as follows. First, an observed image obtained through observation using a low-magnification objective lens is displayed on the monitor 102. An area for which detail observation is to be performed within the observed image is enclosed with a predetermined frame 103 using mouse pointer 104 by a mouse drag operation. Then, the zoom magnification changes in accordance with the size of the area enclosed with the frame 103. Further, the motorized stage 101a moves to the center position of the area enclosed with the frame 103. After that, switching to a high-magnification objective lens is performed, and a detail image of the area enclosed with the frame 103 is displayed.

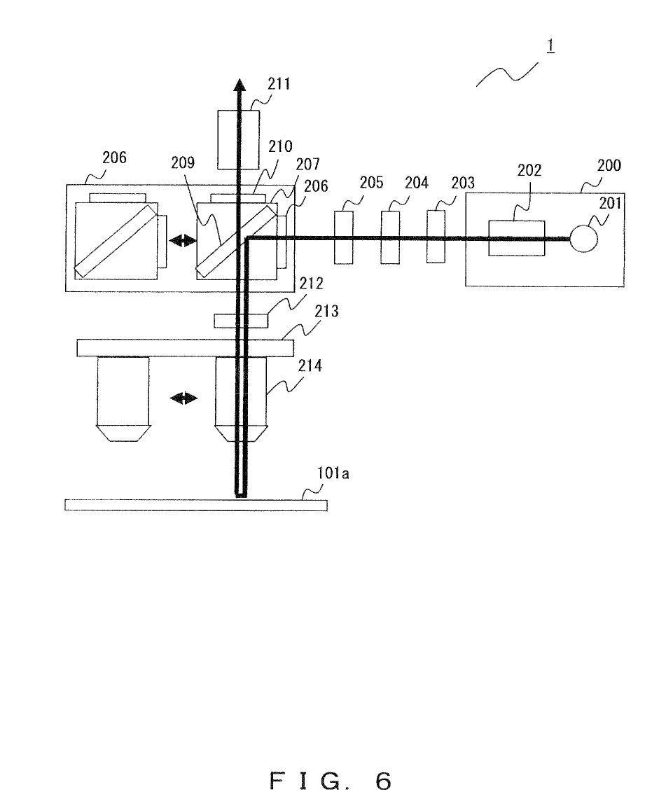

FIG. 6 illustrates the configuration overview of a microscope according to the second embodiment. A microscope 1 is composed of a light source unit 200, a light projection tube, a revolver 213, a stage 101a on which a sample is mounted, and an imaging lens unit 211. The light source unit 200 has a light source 201 and a collector lens 202. The light projection tube has an ND filter 203, a field stop 204, an aperture stop 205 and a cube unit 206 that stores a plurality of cubes 207. The revolver 213 holds a plurality of objective lenses 214 having different magnifications.

The light emitted from the light source 201 in the light source unit 200 goes through the collector lens 202 and enters the light projection tube. The entered light goes through the ND filter 203, field stop 204 and aperture stop 205 in the light projection tube and arrives at the cube unit 206.

The light from the light source 201 that arrived at the cube unit 206 passes through a excitation filter 208 that selectively transmit a particular wavelength, in the cube 207 in the cube unit 206. The light that passed through the excitation filter is reflected on a dichroic mirror 209 in the cube unit 206. The reflected light goes through a shutter 212 and an objective lens 214, and illuminates a sample mounted on the stage 101a.

The fluorescent light emitted from the sample at that time goes through the objective lens 214 and the shutter 212 again, passes through the dichroic mirror 209 and an absorption filter 210 in the cube 207, and enters the image sensor 5 by means of the imaging lens unit 211.

The ND filter 203, field stop 204, aperture stop 205, cube unit 206, revolver 213, shutter 212 and light source unit 200 are respectively connected to the control unit 12. The control unit 12 controls each motorized unit that constitutes the microscope 1.

The ND filter 203, field stop 204, aperture stop 205, cube unit 206, revolver 213, shutter 212 are driven by motor (not shown in the drawings) attached to each part, in accordance with an electric signal from the control unit 12. Accordingly, the insertion/removal of the filter, the field stop diameter, the aperture stop diameter, the type of the cube 207 and the objective lens 214 inserted into the light path, the light blocking status of the illumination light for the sample are changed as needed.

The light source unit 200 controls the voltage applied to the light source 201 in accordance with an instruction from the control unit 12 to change the brightness of the light source 201. When an operation instruction is input from the operator performing the observation, the input unit 13 transmits the operation instruction to the control unit 12.

Hereinafter, the operations of this embodiment are described. The operator performing the observation adjusts, when recording a low-magnification wide-view observed image, each optical member of the microscope 1 so as to obtain a desired observed image, using the input unit 13. Optical member of the microscope include the light source unit 200, ND filter 203, field stop 204, aperture stop 205, cube unit 206, shutter 212 and the like.

To adjust each optical member, for example, the user may select a desired optical member as needed using aGUT (graphical user interface) displayed on the monitor 102 of a PC, or a desired optical member may be selected in accordance with an instruction from the input unit.

When recording the observed image, a brightness I calculated on the basis of the status of each optical member of the microscope is recorded. The calculation formula for the brightness I is defined as follows:

I=(OBr*Rdm*Tbp*AS*FS+ND)*(Tk*Tba*Tdm*OBk)*L (4)

In the above equation, L represents the brightness of the illumination light from the light source 201 that enters the light path of the light projection tube; OBr represents the ratio of input/output brightness at the time an excitation light passes through each objective lens, that is proper to each objective lens; Rdm represents the reflectance of the dichroic mirror 209; Tbp represents the transmittance of the excitation filter 208; AS represents the ratio of brightness of input/output lights, assuming the value when the aperture stop 205 is released as 1; FS represents the ratio of brightness of input/output lights, assuming the value when the field stop 204 is released as 1; ND represents the concentration ratio of the ND filter 203; Tk represents the transmittance of the imaging lens 211; Tba represents the transmittance of the absorption filter 210: Tdm represents the transmittance of the dichroic mirror 209; and OBk represents the ratio of input/output brightness at the time a fluorescent light passes through each objective lens, that is proper to each objective lens.

The optical characteristic information of each optical member of the microscope is stored in an optical characteristic information storage unit 3. The brightness I is calculated using the values of the stored optical characteristic information.

When recording the observed image, brightness I₁ with the use of an objective lens O₁ is calculated and stored in a memory. Then, switching to a high-magnification wide-view objective lens O₂ is performed. When the instruction is input by means of the input unit 13, a brightness I₂ is calculated on the basis of the status of each optical member of the microscope at that time. The difference in the light amounts is calculated from the brightness I₁ and brightness I₂. The flow for calculating the exposure time initial value after that is the same as in the first embodiment and explanation for the same flow is omitted here.

According to this embodiment, the time required for the exposure time for the observed image through the optical members after the switching to settle into the optimal exposure time can be shortened, in consideration of the optical characteristics of various optical members including the objective lenses.

According to the embodiments of the present invention, in a microscope system, an initial value of the exposure time for an observed image through a high-magnification narrow-view objective lens is calculated in advance and set, on the basis of the optical characteristic and image data of the observed image of a low-magnification wide-view objective lens. This makes it possible to shorten the time required for the exposure time for the observed image through the high-magnification narrow-view objective lens to settle into the optimal exposure time.

In addition, since no extra time is required, the damage caused to cells by the illumination can be reduced. Meanwhile, the operator performing the observation can concentrate on other operations such as focusing, as the appropriate exposure can be obtained faster.

Various modifications can be made in any of the embodiments described herein without departing from the scope of the invention. In addition, the processes according to the present invention may be programmed, and a microscope system may be controlled by a computer in which the program is installed.

As described above, without the time and labor to obtain information in advance for each field of view under the same condition, a reasonable exposure time after the switching of objective lenses is calculated in advance using optical characteristic information of the objective lenses and other optical characteristic information. This makes it possible to shorten the time required to attain the original optimal exposure time after the actual switching.

What is claimed is:

1. A microscope system comprising:
a microscope with which a sample mounted on a stage is observed;
an objective lens switching unit switching objective lenses placed in an observation light path;
an imaging unit obtaining an observed image from the microscope;
a storage unit storing optical characteristic information of each of the objective lenses;
a light amount difference calculation unit obtaining optical characteristic information of a first of the objective lenses before switching performed by the objective lens switching unit and optical characteristic information of a second of the objective lenses after the switching from the storage unit, and calculating a difference in amounts of light passing through the two objective lenses; and
an exposure calculation unit calculating an exposure time for a case of performing image capturing through the second objective lens, on the basis of a first observed image captured through the first objective lens, an exposure time for the first observed image, and the calculated difference in the amounts of light.

2. The microscope system according to claim 1, further comprising
an objective lens type detection unit detecting a type of the objective lens placed in the observation light path.

3. The microscope system according to claim 1, further comprising
a sample presence determination unit calculating, from the first observed image, luminance information of a pixel area corresponding to a second observed image captured through the second objective lens, and determining a presence/absence of the sample in the second observed image on the basis of a result of the calculation, wherein
when the sample presence determination unit determines that the sample is present in the second observed image, the exposure calculation unit calculates the exposure time.

4. The microscope system according to claim 1, further comprising:
a position selection unit with which a position of an observed image captured through the second objective lens can be selected in the first observed image; and
a stage moving unit moving the stage such that a position selected by the position selection unit is located in a center of a field of view area in a case of performing observation through the second objective lens.

5. The microscope system according to claim 1, wherein
the storage unit further stores optical characteristic information of optical elements other than the objective lenses placed in the observation light path, and
the light amount difference calculation unit calculates a difference in amounts of light passing through the first and second objective lenses, from optical characteristic information of the optical elements including the objective lenses.

6. A storage medium storing a microscope system control program that causes a computer to perform processes to control a microscope system comprising a microscope with which a stage mounted on a stage is observed, an objective lens switching mechanism switching objective lenses placed in an observation light path and an image capturing apparatus obtaining an observed image from the microscope, the processes comprising:
a light amount difference calculation process for obtaining optical characteristic information of a first of the objective lenses before switching performed by the objective lens switching mechanism and optical characteristic information of a second of the objective lenses after the switching from a storage apparatus storing optical characteristic information of each of the objective lens, and calculating a difference in amounts of light that passes through the two objective lenses; and
an exposure time calculation process calculating an exposure time for a case of performing image capturing through the second objective lens, on the basis of a first observed image captured through the first objective lens, an exposure time for the first observed image, and the calculated difference in the amounts of light.

7. A microscope system control method for a microscope system comprising a microscope with which a stage mounted on a stage is observed, an objective lens switching mechanism switching objective lenses placed in an observation light path and an image capturing apparatus capturing an observed image from the microscope, comprising:
obtaining optical characteristic information of a first of the objective lenses before switching performed by the objective lens switching mechanism and optical characteristic information of a second of the objective lenses after the switching from a storage apparatus storing optical characteristic information of each of the objective lens, and calculating a difference in amounts of light passing through the two objective lenses; and
calculating an exposure time for a case of performing image capturing through the second objective lens, on the basis of a first observed image captured through the first objective lens, an exposure time for the first observed image, and the calculated difference in the amounts of light.
